(19) United States
(12) Patent Application Publication
(10) Pub. No.: US 2025/0305164 A1
(43) Pub. Date: Oct. 2, 2025

(54) WATER ELECTROLYZER SYSTEM

(71) Applicant: Robert Bosch GmbH, Stuttgart (DE)

(72) Inventors: Markus Berger, Vaihingen An Der Enz (DE); Annika Utz, Ditzingen (DE); Joerg Ziuber, Karlsruhe (DE)

(21) Appl. No.: 18/864,655

(22) PCT Filed: May 17, 2023
(86) PCT No.: PCT/EP2023/063215

§ 371 Date: Nov. 11, 2024

(30) Foreign Application Priority Data
May 17, 2022 (DE) 10 2022 204 834.2

(51) Int. Cl. C25B 9/65; C25B 15/08

(52) U.S. Cl. CPC C25B 9/66; C25B 15/08

(57) ABSTRACT

The invention relates to a water electrolyzer system (1) for producing hydrogen. According to the invention, the water electrolyzer system (1) comprises an electrolysis stack (8) for converting water into hydrogen, a power electronics means (12) for transforming the alternating current into a direct current in order to supply the electrolysis stack (8), components (56, 64, 72, 80) for preparing the process media supplied to and discharged from the electrolysis stack (8), and a control unit (18) for controlling the electrolysis stack (8), as well as the power electronics means (12) and the components (56, 64, 72, 80) for preparing the media. At least the electrolysis stack (8), the power electronics means (12), and the control unit (18) are formed together as an electrolyzer module (36), and the components (56, 64, 72, 80) for preparing and conveying the media are formed together as a process module (52). The modules (36, 52) are provided with connection means (32, 40, 48, 84), via which the individual modules (36, 52) can be fluidically and electrically connected together.

### BACKGROUND

The present invention relates to a water electrolyzer system for producing hydrogen. The invention further relates to a hydrogen facility comprising at least one such water electrolyzer system.

The core of a PEM water electrolyzer is the electrolysis stack. In this context, the general trend for industrial hydrogen production is towards very high-output units with multiple MW output. The electrolyzer also comprises various supply units, which are referred to as a Balance of Plant (BoP). These units include water pumps, gas-water separators, ion filters, heat exchangers, temperature sensors, pressure sensors, gas sensors, ultrapure water treatment, hydrogen aftertreatment and purification, transformers, rectifiers, controllers and control units, cables, tubes, and valves. How these components are connected to each other and whether these components supply a stack or multiple stacks is within the manufacturer's design and discretion. Depending on the design principle, a variety of compositions and pre-assembled units may be advantageous.

DE 10 055 973 A1 discloses a marine power plant comprising multiple individual power systems, each having its own energy storage apparatus. The power systems are in this case electrically connected to a bus bar. The energy storage apparatuses comprise electrolyzers, using which hydrogen and oxygen can be produced from water stored in pressurized tanks. Arranged in the energy storage apparatus is fuel cell arrangement, using which electrical energy is generated from the hydrogen.

An energy generation and management system is known from DE 20 2019 003 849 U1. The system in this case comprises multiple solar panels and multiple wind power plants for generating power. The system comprises one or multiple electrolyzers, using which water, hydrogen, and oxygen can be produced.

When constructing the electrolyzer at the customer site (e.g., adjacent to a solar panel), the costs are primarily dependent on transport to the work site and the cost of assembly and initial service. The delivery of individual components may in this case be favorable for transport, and the assembly and initial service process requires a great deal of time and personnel.

The object underlying the invention is to specify a water electrolyzer system that enables a simpler, faster, and more cost-efficient design for such a system.

This object is achieved by means of a water electrolyzer system according to the disclosure. Preferred embodiments can be gathered from the dependent claims.

### SUMMARY

The invention specifies a water electrolyzer system for producing hydrogen. The water electrolyzer system comprises at least one electrolysis stack for converting water into hydrogen, a power electronics means for supplying the electrolysis stack, components for preparing the process media and for conveying the media supplied to and discharged from the electrolysis stack, and a control unit for controlling the electrolysis stack, the power electronics means, and the components for preparing and conveying the media. At least the electrolysis stack, the power electronics means, and the control unit are formed together as an electrolyzer module, and the components for preparing the media and for conveying the media are formed together as a process module, whereby the modules are provided with connection means, via which the individual modules can be fluidically and electrically connected together.

The electrolysis stack is advantageously a PEM electrolysis stack. In the context of the intention, a module is understood to mean a structural unit which is manufactured together in a manufacturing facility. These modules are preferably manufactured in an automated manner. After manufacture, the modules are, e.g., transported by truck or ship to the location where a hydrogen facility is intended to be erected or extended. According to the invention, the electrolyzer system comprises only the assemblies of the electrolysis module, the process module, and the control module. A plurality of these modules can be provided in this case, depending on the size of the hydrogen production facility. Automated manufacturing at the facility significantly reduces the time and manpower required to set up and connect the individual components and reduce the cost of such a plant.

The modules can in this case be constructed and extended according to a modular concept. The modular design additionally reduces the transport effort because fewer trips are required in order to bring all components on site by aggregating the individual components into modules. For the sake of electrolyzer module transportabililty, the electrolysis stacks have a power output of no more than 1 MW. Given such an output, the weight will not not exceed any limit value necessary for transportability. Preferably, the power of the electrolysis stack is between 500 kW and 1500 kW. The modules only need to be connected on site via the connection means which can, e.g., be designed in a standardized manner. Therefore, only lines between these connection means are necessary, thereby decreasing the number of lines. As a result, the effort required to connect the modules to one another is also reduced. In preferred embodiments, the electrolyzer module, or all of the water electrolyzer system, is arranged in a sea freight container housing.

In one advantageous embodiment, the power electronics means is designed to transform an alternating current into direct current. Direct current must be applied to the electrolysis stacks. If the water electrolyzer system is supplied with alternating current, then a corresponding transformation is necessary.

In one preferred embodiment of the invention, the connection means are designed as plug and/or flange connections. The use of plug and flange connections has the advantage that connections need not be made via, for example, complex welds. Welding costs can be reduced as a result. In addition, the connections can be formed quickly by, e.g., tightening bolts. As a result, the modules are able to be connected quickly and inexpensively.

In one further preferred embodiment of the invention, the modules are connected to one another solely by pre-assembled process media lines and power lines. In other words, the prefabricated process media and power lines have, e.g., already been manufactured in an automated production process. These are only attached in order to connect the connection means. Therefore, no connection lines need be installed in a laborious way. Again, the manufacturing costs of such a water electrolyzer system and the time required to do so are significantly reduced as a result.

Particularly preferably, a power line is designed as a common power bus which extends into both the electrolyzer module and the process module. All of the electrical consumers from the electrolyzer module and the process module can be connected to the power bus. Consequently, the consumers are preferably only powered by electrical current via this power bus.

Advantageously, a process module is associated with multiple electrolyzer modules. As a result, such a water electrolyzer system can be scaled to larger plants. Depending on the output, individual components for preparing the media and for conveying the process media can then be associated with the process module, i.e. supplying multiple electrolyzer modules, or the individual electrolyzer modules themselves, i.e. supplying only one electrolyzer module at a time. The plant for the water electrolyzer system therefore remains variable, in particular in terms of output.

In advantageous embodiments, the electrolyzer module comprises multiple electrolysis stacks. This is particularly advantageous if the design space size—e.g. a sea freight container—enables the arrangement of multiple electrolysis stacks in an electrolyzer module. Furthermore, this is advantageous if multiple electrolysis stacks can share a control unit of the electrolyzer module.

Preferably, the connection means is designed such that a data connection and a power connection can be connected via a common plug. The plug therefore comprises contacts for establishing a power connection, as well as contacts for a data connection. Therefore, only a single plug is necessary to ensure a power connection and data connection. The advantage of a plug is that no tools are necessary to prepare the power and data cables for a connection and to connect them. As a result, a connection can be established in a quick and straightforward manner. Advantageously, the plugs are designed such that they cannot be mixed up, so a non-skilled person can also correctly connect them.

In one advantageous embodiment, the process module additionally comprises a pump for circulating the water through the electrolysis stack. The arrangement of the pump in the process module has the advantage that the pump can supply multiple electrolyzer modules.

In one alternative advantageous embodiment, the electrolyzer module comprises the pump for circulating the water through the electrolysis stack. An arrangement of the pump in the electrolyzer module, rather than the arrangement in the process module, has the advantage that a smaller pump can be used for each electrolyzer module. In addition, if the pump fails, then not all electrolyzer modules are deactivated, but only the electrolyzer module in which the pump is arranged. As a result, the water electrolyzer system remains operational, so redundancy is created. In the case of a pump, if metal chips are fed into the electrolysis stack due to a defect, it is only this electrolysis stack that needs to be replaced, rather than all electrolysis stacks.

Advantageously, the modules are designed such that their size is less than or equal to the size of a sea freight container. The size of such a sea freight container is defined according to an ISO standard. The advantage of such containers is that they can be transported simply by ship, rail, or truck. Therefore, no heavy-duty transport and no special transport route are necessary to transport the modules to the work site. As a result, the cost and time for transporting the components is significantly reduced.

In another advantageous embodiment, the electrolyzer module and the control unit together comprise a common connection means to the process module. In this context, a common connection means is understood to mean that the connectors for the control unit and the electrolyzer module are arranged directly adjacent to one another. Therefore, only the process module need be connected to the common connection means. As a result, the connection of the modules is further simplified, so only power lines and process lines need be provided between the common connection means and the process module.

The common connection means is advantageously arranged such that, for positioned modules, the distance between the common connection means and a connection means on the process module is minimal, or they are arranged directly opposite.

According to one advantageous embodiment, multiple electrolyzer modules form a common connection means to the process module. The multiple electrolyzer modules are therefore arranged in a common housing. Within the housing, the process lines and data lines of the electrolyzer modules are connected to each other and provide a single common connection means of all electrolyzer modules to the process module on the housing. The connections of the electrolyzer modules are in this case preferably automated with one another, preferably during the course of manufacturing the modules. The manufacturing costs for connecting the electrolyzer modules to each other are thereby reduced because the modules need not be formed locally. Therefore, it is only necessary to establish a connection between the common connection means and the process module.

Further specified is a hydrogen facility, which comprises at least one such water electrolyzer system. Given such a hydrogen facility, the advantages specified hereinabove are substantially achieved. Therefore, such a hydrogen facility can be quickly, economically, and easily constructed. In addition, the modular design ensures a simple extension means for the hydrogen facility, in particular the output rating thereof.

### BRIEF DESCRIPTION OF THE DRAWINGS

Exemplary embodiments of the invention are shown in the drawings and explained in more detail in the subsequent description. Shown are:

FIG. 1 water electrolyzer system according to an exemplary embodiment of the invention.

FIG. 2 water electrolyzer system according to a further exemplary embodiment of the invention.

### DETAILED DESCRIPTION

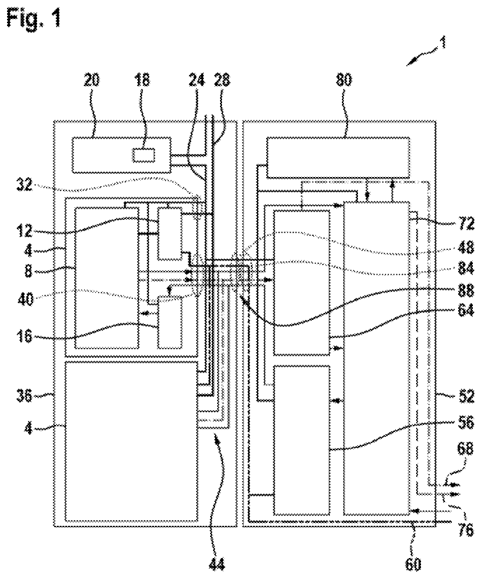

FIG. 1 shows a water electrolyzer system 1 according to an exemplary embodiment of the invention. The water electrolyzer system 1 according to this exemplary embodiment comprises two electrolysis modules 4, each comprising an electrolysis stack 8 (only shown for one electrolysis module) for converting water into hydrogen. In addition, a power electronics means 12 is arranged in the electrolysis module 4, via which means a supplied alternating current is preferably converted into a direct current. Also arranged in the electrolysis module 4 is a pump 16, using which water or the process medium can be circulated through the electrolysis stack 8.

The water electrolyzer system 1 additionally comprises a control unit 18, which is arranged in a control device 20. The control unit 18 is connected to the electrolysis modules 4 via control data lines 24 in order to control the electrolysis stacks 8, the power electronics means, 12 and the pump 16. The control data line 24 is connected together with a power line 28 to a common first electrolysis module connection means 32. Both lines 24, 28 can be connected to the first electrolysis module connection means 32 designed as a socket via a common plug.

In this embodiment, the two electrolysis modules 4 and the control unit 18 are arranged in a common electrolyzer module 36, which is preferably accommodated in a housing, e.g. a sea freight container. A second electrolysis module connection means 40 is arranged on the electrolysis modules 4, via which process media lines 44 of the electrolysis modules 4 are connected to a common housing connection means 48. A control data line 24 of the control unit 18 is also connected to this common housing connection means 48.

The water electrolyzer system 1 additionally comprises a process module 52 comprising various components for processing and conditioning the process media. In the exemplary embodiment shown, the process module 52 comprises a heat exchanger 56, using which the cooling water for the power electronics means 12 and the water for the electrolysis stack 8 is cooled. The heat exchanger 56 is connected to a cooling water connector 60 for this purpose. Also arranged in the process module 52 is a cathode gas-water separator 64, in which the hydrogen coming from the cathode is separated from the cathode process medium and directed to a hydrogen connector 68.

Further arranged in the process module 52 is an anode gas-water separator 72, in which the oxygen is separated from the anode process medium and directed to an oxygen connector 76. The process medium is deionized in an ion exchanger 80 for use in the electrolysis stack 8.

The process module 52 comprises a common process module connection means 84, to which the components of the process module 52 are connected. Connection lines 88 connect the housing connection means 48 to the process module connection means 84.

In preferred embodiments, the power line 28 is designed as a common power bus. Both electrolysis modules 4, as well as the control module 20 and the process module 52, comprise electrical connections to this common power bus.

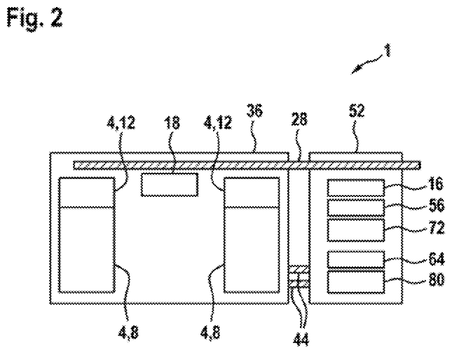

Shown in FIG. 2 is a further water electrolyzer system 1 according to a further exemplary embodiment of the invention. The water electrolyzer system 1 comprises two electrolysis modules 4, each comprising an electrolysis stack 8 and a power electronics means 12. The power electronics means 12 preferably comprises grid switches and/or transformers. Together with the control unit 18, the two electrolysis modules 4 form an electrolyzer module 36. The water electrolyzer system 1 further comprises a process module 52. The pump 16, the heat exchanger 56, the cathodes gas-water separator 64, the anodes gas-water separator 72, and the ion exchanger 80 are arranged in the process module 52.

Process media lines 44 are arranged between the electrolyzer module 36 and the process module 52, via which media lines the media being guided (in particular water and hydrogen) run between the two modules 36, 52.

In preferred embodiments, the water electrolyzer system 1 further comprises the power bus designed as a common power line 28 which extends into both the electrolyzer module 36 and the process module 52. The electrical consumers, e.g. the electrolysis stacks 8, the pump 16, and the control unit 18, comprise electrical connectors to the power bus 28.

1. A water electrolyzer system (1) for producing hydrogen, comprising at least the following:
an electrolysis stack (8) for converting water into hydrogen,
a power electronics means (12) for supplying the electrolysis stack (8),
components (16, 56, 64, 72, 80) for preparing and conveying the process media supplied to and discharged from the electrolysis stack (8), and
a control unit (18) for controlling the electrolysis stack (8), the power electronics means (12), and the components (16, 56, 64, 72, 80) for preparing and conveying the media,
wherein
at least the electrolysis stack (8), the power electronics means (12), and the control unit (18) are formed together as an electrolyzer module (36), and the components (16, 56, 64, 72, 80) for preparing and conveying the media are formed together as a process module (52), wherein the modules (36, 52) are provided with connection means (32, 40, 48, 84), via which the individual modules (36, 52) can be fluidically and electrically connected together.

2. The water electrolyzer system (1) according to claim 1, wherein the power electronics means (12) is designed to transform alternating current into direct current.

3. The water electrolyzer system (1) according to claim 1, wherein the connection means (32, 40, 48, 84) are designed as plug and/or flange connections.

4. The water electrolyzer system (1) according to claim 1, wherein the modules (36, 52) are connected to one another only using pre-assembled process media lines and power lines (28).

5. The water electrolyzer system (1) according to claim 4, wherein a power line (28) is designed as a common power bus that extends into both the electrolyzer module (36) and the process module (52).

6. The water electrolyzer system (1) according to claim 1, wherein the electrolyzer module (36) comprises multiple electrolysis stacks (8).

7. The water electrolyzer system (1) according to claim 1, wherein the process module (52) is connected to one or multiple electrolyzer modules (36) by means of process media lines (44).

8. The water electrolyzer system (1) according to claim 1, wherein the connection means (32, 40, 48, 84) is designed such that a data and power connection can be connected via a common plug.

9. The water electrolyzer system (1) according to claim 1, wherein the connection means (32, 40, 48, 84) is designed such that all process media can be connected via a common plug.

10. The water electrolyzer system (1) according to claim 1, wherein the process module (52) comprises a pump (16) for circulating the water through the at least one electrolysis stack (8).

11. The water electrolyzer system (1) according to claim 1, wherein the electrolyzer module (36) comprises a pump (16) for circulating the water through the at least one electrolysis stack (8).

12. The water electrolyzer system (1) according to claim 1, wherein the modules (36, 52) are designed such that their size is less than or equal to the size of a sea freight container.

13. The water electrolyzer system (1) according to claim 1, wherein the electrolysis stack (8), the power electronics means (12), and the control unit (18) together comprise a common connection means (48) to the process module (52).

14. The water electrolyzer system (1) according to claim 1, wherein multiple electrolysis stacks (8) form a common connection means (48) to the process module (52).

15. A hydrogen facility comprising at least one water electrolyzer system (1) according to claim 1.
